(19) United States
(12) Patent Application Publication
(10) Pub. No.: US 2003/0017866 A1
(43) Pub. Date: Jan. 23, 2003

(54) Roulette driving apparatus and method of controlling a roulette-type disc changeable player

(75) Inventors: Tae-myun Kim, Gyeonggi-do (KR); Go-hyun Kim, Gyeonggi-do (KR); Dong-man Kim, Seoul (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 10/032,451

(22) Filed: Jan. 2, 2002

(30) Foreign Application Priority Data
Jul. 23, 2001 (KR) 2001-44202

(51) Int. Cl. A63F 13/00

(52) U.S. Cl. 463/17; 463/47

(57) ABSTRACT

A roulette driving apparatus used with a roulette-type disc changeable player to rotate a roulette where a plurality of discs are loaded, including a motor, a worm gear installed on the rotation shaft of the motor, and a driving gear rotating in a state in which it is geared to the worm gear and to a gear provided on the roulette, transmitting power generated from the motor to the roulette. Since the roulette driving apparatus used with a roulette-type disc changeable player is configured to transmit power from a motor directly to a roulette through a worm gear and a driving gear, the number of parts can be greatly reduced compared to the conventional apparatus. Also, since the number of power transmission steps is reduced, the reduction ratio is reduced so that a desired angle of rotation of the roulette can be achieved by driving the motor to a lesser extent, thereby considerably reducing noise generated by driving the roulette.

### CROSS-REFERENCE TO RELATED APPLICATIONS

This application claims the benefit of Korean Patent Application No. 2001-44202 filed on Jul. 23, 2001, in the Korean Industrial Property Office, the disclosure of which is incorporated herein by reference.

### BACKGROUND OF THE INVENTION

1. Field of the Invention

The present invention relates to a roulette driving apparatus and method of rotationally driving a roulette in a roulette-type disc changeable player configured to reproduce signals from a plurality of discs loaded on the roulette while automatically replacing the discs.

2. Description of the Related Art

In general, a roulette-type disc changeable player, as shown in FIG. 1, loads a plurality of discs (not shown) on a roulette 20 rotatably installed on a tray 10 and sends one disc, which is selected from the plurality of discs, to a recording and/or reproducing unit 30 to perform recording or reproduction. Once a disc is selected, the roulette 20 rotates to position the selected disc on the recording and/or reproducing unit 30 to be chucked between a turntable 31 and a damper 32 to be used.

To this end, a driving apparatus driving the roulette 20 is provided on the tray 10. A conventional roulette driving apparatus, as shown in FIGS. 1 and 2, includes a motor 41, a driving pulley 42 installed on the shaft of the motor 41, a driven pulley 44 connected to the driving pulley 42 by a belt 43 to be rotated, a worm gear 45 coaxially installed with the driven pulley 44, and a driving gear 46 connecting the worm gear 45 with a gear 21 provided on the bottom surface of the roulette 20 to transmit power, generated from the motor 41, to the roulette 20. If the motor 41 is driven, the driving pulley 42 and the driven pulley 44, which are connected with each other by the belt 43, are rotated. Accordingly, the worm gear 45 and the driving gear 46 rotate and transmit the power to the gear 21 of the roulette 20, thereby rotating the roulette 20. Reference numeral 45a denotes a holder rotatably supporting the worm gear 45, and reference numeral 11 denotes rotation guide rollers rotatably supporting the roulette 20.

In the above-described configuration, since the power is transmitted from the motor 41 to the gear 21 of the roulette 20 through several steps, the number of parts necessary to transmit power increases undersirably. That is to say, the power of the motor 41 is first transmitted to the driving pulley 42, the belt 43, and the driven pulley 44, and then transmitted to the gear 21 of the roulette 20 via the worm gear 45 and the driving gear 46. Accordingly, there is an increase in the number of parts necessary for relaying power. Also, if the multiple-step power transmission mechanism including, for example, the pulleys 42 and 44 and the belt 43, is employed, the reduction ratio from the motor 41 to the gear 21 of the roulette 20 increases. Thus, the number of revolutions of the motor 41 to rotate the roulette 20 increases. In other words, if the reduction ratio increases, the motor 41 must be rotated to a greater extent to rotate the roulette 20 by a predetermined angle of rotation, which may increase noise during rotation of the roulette 20.

Thus, there is an increasing demand for a new roulette driving apparatus that can solve the problems existing with respect to the conventional apparatus.

### SUMMARY OF THE INVENTION

Accordingly, it is an object of the present invention to provide an improved roulette driving apparatus used with a disc changeable player configured to transmit the power from a motor to a roulette with a reduced number of parts.

Additional objects and advantages of the invention will be set forth in part in the description which follows and, in part, will be obvious from the description, or may be learned by practice of the invention.

The foregoing and other objects of the present invention are achieved by providing a roulette driving apparatus used with a roulette-type disc changeable player to rotate a roulette where a plurality of discs are loaded, including a motor, a worm gear installed on the rotation shaft of the motor, and a driving gear rotating in a state in which it is geared to the worm gear and to a gear provided on the roulette, to transmit power generated from the motor to the roulette.

The above and other objects of the present invention may also be achieved by providing a method of driving a roulette used with a roulette-type disc changeable player, the method comprising transmitting power from a motor to a roulette by applying a force from the motor worm gear directly to a roulette driving gear to rotate said roulette.

### BRIEF DESCRIPTION OF THE DRAWINGS

These and other objects and advantages of the present invention will become more apparent and more readily appreciated from the following description of the preferred embodiments, taken in conjunction with the accompany drawings in which:

FIG. 1 is a schematic diagram of a roulette-type disc changeable player employing a conventional roulette driving apparatus;

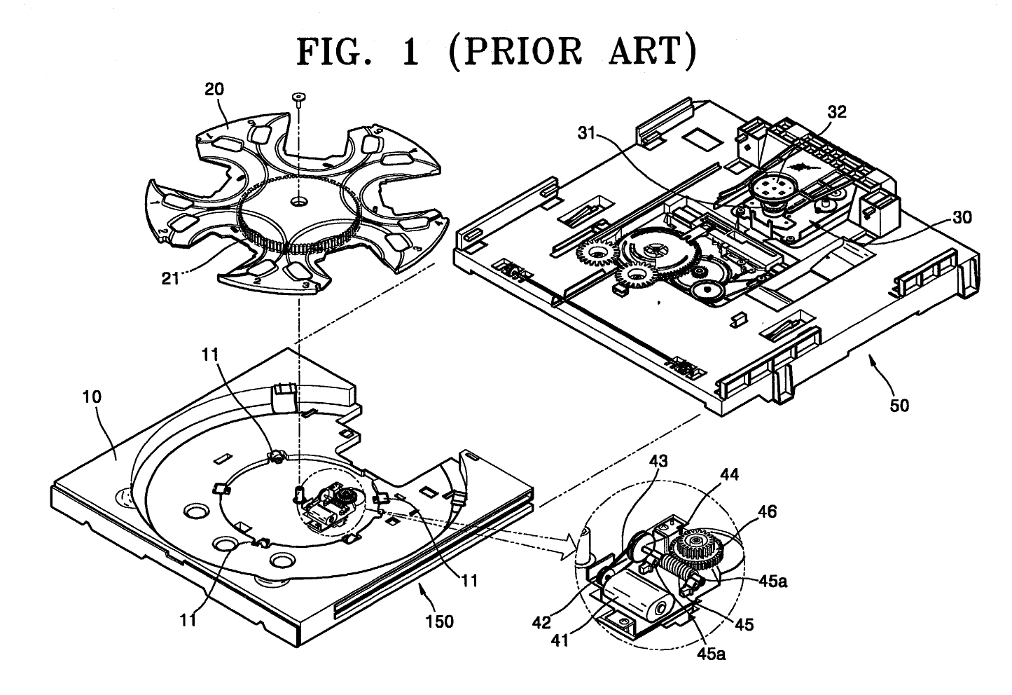

FIG. 2 is a plan view of the roulette driving apparatus shown in FIG. 1;

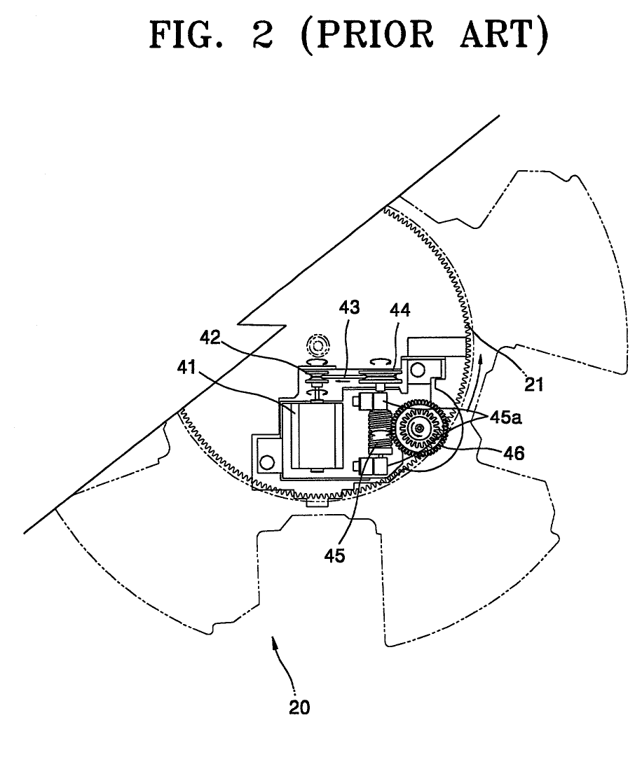

FIG. 3 is a schematic diagram of a roulette-type disc changeable player employing a roulette driving apparatus according to the present invention; and

FIG. 4 is a plan view of the roulette driving apparatus shown in FIG. 3;

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

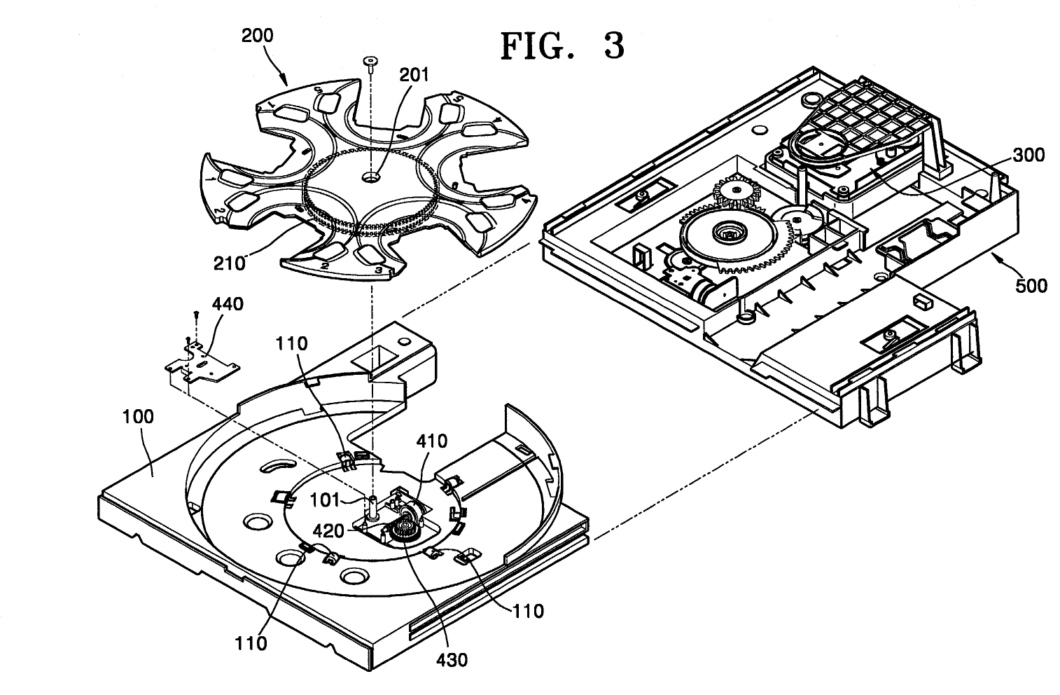

Referring to FIG. 3 showing a roulette-type disc changeable player employing a roulette driving apparatus according to the present invention, a tray 100 is reciprocally installed on a deck 500 on which a recording and/or reproducing unit 300 is installed, and a roulette 200 is rotatably installed on the tray 100. The roulette driving apparatus according to the present invention rotatably driving the roulette 200 is installed on the tray 100.

The roulette driving apparatus includes a motor 410 installed on the tray 100, a worm gear 420 installed directly on the rotation shaft of the motor 410 and a driving gear 430 geared to the worm gear 420 and a gear 210 provided on the bottom surface of the roulette 200. The gear 210 transmits power generated from the motor 410 to the roulette 200. In other words, the roulette driving apparatus according to the present invention is configured such that the roulette 200 can be rotated just by the worm gear 420 installed on the rotation shaft of the motor 410 and the driving gear 430 geared to the worm gear 420. Reference numeral 440 denotes a motor bracket, reference numeral 101 denotes a boss inserted into a center hole 201 provided on the roulette 200, and reference numeral 110 denotes rotation guide rollers rotatably supporting the roulette 200.

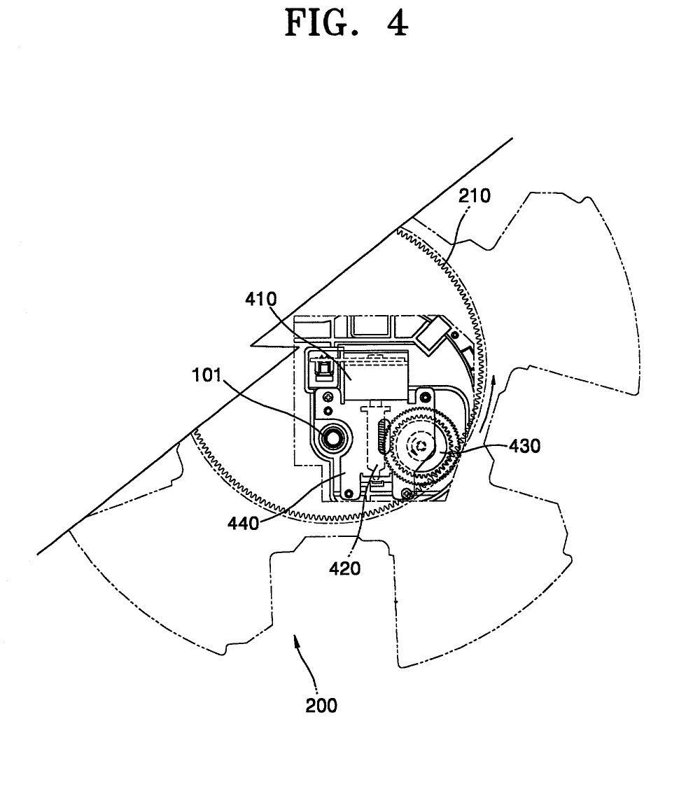

In the above-described configuration, if the motor 410 is driven, as shown in FIG. 4, the worm gear 420 and the driving gear 430 rotate, and then the roulette 200, connected through the gear 210, is rotated. In other words, unlike the conventional configuration in which pulleys and a belt are used in the power transmission mechanism, the power of the motor 410 can be transmitted with only the worm gear 420 and the driving gear 430, thereby greatly reducing the power transmission operations to rotate the roulette 200.

Therefore, the roulette driving apparatus according to the present invention has a considerably reduced number of parts compared to the conventional apparatus, so that the management of parts and assembling work can be facilitated. Also, reducing the power transmission steps by eliminating pulleys and a belt results in a relatively smaller reduction ratio, thereby rotating the roulette 200 rapidly. Further, the roulette 200 can be rotated through the same angle of rotation with a smaller number of revolutions of the motor 410. In other words, since the driving time and the number of rotations of the motor 410 can be reduced while the roulette 200 rotates, noise generated by driving of the motor 410 can be effectively reduced.

As described above, since the roulette driving apparatus used with a roulette-type disc changeable player according to the present invention is configured to transmit power from a motor directly to a roulette through a worm gear and a driving gear, the number of parts can be greatly reduced compared to the conventional apparatus. Also, since the number of power transmission steps are reduced, the reduction ratio is reduced so that a desired angle of rotation of the roulette can be achieved by driving the motor to a lesser extent, thereby considerably reducing noise generated by driving the roulette.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A roulette driving apparatus used with a roulette-type disc changeable player rotating a roulette with a gear provided thereon and where a plurality of discs are loaded, comprising:
a motor having a rotation shaft;
a worm gear installed on the rotation shaft of the motor; and
a driving gear rotating while geared to the worm gear and to the gear provided on the roulette, transmitting power generated from the motor to the roulette.

2. The roulette driving apparatus according to claim 1, further comprising:
a recording and/or reproducing unit;
wherein once one of the discs is selected, said roulette rotates to position said selected disc on said recording and/or reproducing unit.

3. A roulette-type disc changeable player including a roulette with a gear provided thereon and where a plurality of discs are loaded and a roulette driving apparatus rotating the roulette, wherein the roulette driving apparatus comprises:
a motor;
a worm gear installed on the rotation shaft of the motor; and
a driving gear rotating while geared to the worm gear and to the gear provided on the roulette, transmitting power generated from the motor to the roulette.

4. A method of driving a roulette used with a roulette-type disc changeable player having a roulette with a gear provided thereon, the method comprising:
transmitting power from a motor by directly applying a force from a worm gear installed on a rotation shaft of the motor to a drive gear engaged with the worm gear and the gear provided on the roulette.

5. The method according to claim 4, further comprising:
selecting a disc; and
rotating said disc to a position on a recording and/or reproducing unit.
